(19) United States
(12) Patent Application Publication
(10) Pub. No.: US 2003/0080046 A1
(43) Pub. Date: May 1, 2003

(54) Fuel filtration device

(75) Inventor: Kouichi Ito, Sasima-gun (JP)

Correspondence Address: OLIFF & BERRIDGE, PLC, P.O. BOX 19928, ALEXANDRIA, VA, 22320, US

(73) Assignee: KYOSAN DENKI CO., LTD., Sasima-gun (JP)

(21) Appl. No.: 10/281,122

(22) Filed: Oct. 28, 2002

(30) Foreign Application Priority Data
Oct. 29, 2001 (JP) 2001-330321

(51) Int. Cl. B01D 35/02

(52) U.S. Cl. 210/416.4; 210/491; 210/487

(57) ABSTRACT

A fuel filtration device includes a filter medium in which at least two opposing surfaces are formed, an inner portion space that is surrounded by the filter medium and where liquid accumulates, and a connecting member that connects the inner portion space and the outer portion and delivers the liquid in the inner portion space to the outer portion. The filter medium is a non-woven fabric made of material fibers and adhesive fibers, and by melting the adhesive fibers, the fibers are joined.

### INCORPORATION BY REFERENCE

The disclosure of Japanese Patent Application No. 2001-330321 filed on Oct. 29, 2001 including the specification, drawings and abstract is incorporated herein by reference in its entirety.

### BACKGROUND OF THE INVENTION

1. Field of Invention

The invention relates to a modified structure of a fuel filtration device. In particular, the invention relates to a modified structure of an in-tank type fuel filtration device that is installed in a fuel tank such as for an automobile.

2. Description of Related Art

FIG. 11 shows a fuel tank installed in an automobile. A fuel pump 3 that supplies fuel to a fuel injection device 4 is located in the fuel tank 1. A fuel filtration device 2 is attached via a connecting member 7 to a fuel intake side that is on an upstream side of the fuel pump 3.

FIG. 12 shows the details of the fuel filtration device 2. The fuel filtration device 2 is connected to the fuel pump 3 via the connecting member 7, and because another edge of the fuel filtration device 2 contacts a bottom wall 9 of the fuel tank 1, the fuel pump 3 can intake sufficient fuel via the filtration device 2 even if the fuel level is low.

The fuel filtration device 2 includes a filtration medium 5 that is made of a non-woven fabric having a plurality of holes and made of a synthetic resin, and a protector 6 that is located in the inner portion. The protector 6 is made of a synthetic resin and prevents adherence between filter mediums 5, and sufficiently secures an inner portion space 8 and maintains a stable fuel passage.

An outline of the assembly of the fuel filtration device 2 that includes the three parts of the filter medium 5, the protector 6 and the connecting member 7 is as follows. The filter medium 5 that is made of a non-woven fabric and is folded vertically, or the filter medium 5 that has two layers is provided, and a through hole for the connecting member 7 is formed in a side surface of the filter medium 5. After that, the connecting member 7 is inserted inside the through hole, and the filter medium 5 around the through hole is clamped by the connecting member 7 and the protector 6, and the filter medium 5, the protector 6 and the connecting member 7 are assembled such that they are airtight. After that, the periphery of the filter medium 5 is sealed such that the protector 6 is wrapped therein using ultrasonic welding, etc., and the bag shape fuel filtration device 2 is formed.

Because the protector 6 is provided on the inner portion of this kind of intake type fuel filtration device 2, adherence between filter mediums 5 can be prevented and an inner portion space 8 can be sufficiently secured. Further, by attaching the connecting member 7 to the filter medium 5, the fuel filtration device 2 and the fuel pump 3 can be easily and reliably connected.

The non-woven fabric that is used as the filter medium is made from material fibers 5a that use polyester, polypropylene, rayon, glass, acetate, nylon, etc. The non-woven fabric is made by gathering the material fibers 5a and forming it into a cloth form, and is porous, making it suitable for use as a filter medium. However, as can be seen from the cross section of the filter medium shown in FIG. 13, most of the fiber hairs 5b on the surface of the filter medium are raised.

However, the in-tank type fuel filter device 2 is attached contacting a bottom wall 9 of the fuel tank 1 so that even when the fuel in the fuel tank 1 is at a low level it can sufficiently intake the fuel. Therefore, the fuel tank 1 constantly vibrates during driving, and the low surface of the fuel filtration device is in friction with the bottom wall 9 of the fuel tank 1. Therefore, the filtration device 2 that is formed only of non-woven fabric wears on the low surface and sometimes there is breakage.

Also, when the bag shape filter medium is formed from the nonwoven fabric, most of the fiber hairs 5b on the inner surface of the filter medium 5 are also raised. The fiber hairs 5b peel away from the material fibers 5a and mix with the fuel and flow into the fuel pump 3 and lock the fuel pump 3 at times.

According to the related art of the invention, in order to prevent the peeling of the fiber hairs 5b on the inner surface of the filter medium and the friction from the bottom wall 9 of the fuel tank 1 on the outer surface, a protective layer is provided on the internal and outer surfaces. In other words, as shown in FIG. 14, on the inner surface side of the filter medium 5, in other words, the side where the protector 6 is disposed, a relatively coarse cover layer 5c for preventing raising of hair is disposed, and on an opposite surface, in other words, an outer surface on the side that contacts the bottom wall 9 of the fuel tank 1, a mesh screen layer 5d is disposed, and the three layers are fixed in place by performing heat welding at a plurality of spots. Further, the outlined arrow as shown in FIGS. 14 and 15 indicates the flow direction of the fuel from the outer side of the filter medium 5 to the inner side.

Also, recently, in order to improve the filtration capability of the filter medium 5, the filter medium 5 has a multi-layer structure that includes a coarse layer or a dense layer. FIG. 15 shows the filter medium having a multi-layer structure that includes a coarse layer or a dense layer. The filter medium 5 with a multi-layer structure is formed from three layers of a coarse layer 51, a middle layer 52 and a dense layer 53. The coarse layer 51 side is the fuel tank 1 side, and the dense layer 53 side is the inner surface side of the filter medium 5 where the protector 6 is disposed, and, as in FIG. 14, the fuel flows in the direction of the outlined arrow that shows the flow direction of the fuel from the outer side of the filter medium 5 to the inner side. The fuel is drawn from the coarse layer 51 side and as it passes through the middle layer 52 and the dense layer 53, large and small foreign materials are filtered by each layer, and the fuel flows into the filter medium 5 where the protector 6 is provided.

However, even in the filter medium 5 with a multi-layer structure, the problems mentioned above, in other words, the problem with the wear from friction with the bottom wall 9 of the fuel tank 1 on the coarse layer 51 side, and the problem with the peeling of the fiber hairs 5b of the material fibers 5a on the dense layer side and the adverse effect on the fuel pump 3 occur. Therefore, even in this type of filter medium with a three-layer structure, the same protective means as explained in FIG. 14 is adopted.

In other words, as shown in FIG. 15, the relatively coarse cover layer 5c for preventing raising of hair is disposed on the inner surface side of the filter medium 5, that is, the dense layer 53 side where the protector 6 is disposed. A mesh screen layer 5d is disposed on a surface opposing the surface where the cover layer 5c is disposed, that is, on an outer surface of the coarse layer 51 side that contacts the bottom wall 9 of the fuel tank 1, and the five layers are fixed in place by performing heat welding at a plurality of spots.

The filter medium with a three-layer structure in FIG. 14, and the filter medium with a five-layer structure in FIG. 15 can both solve the above mentioned problems and pose no problems as a filter medium. However, as mentioned above, the filter mediums with a separate three-layer structure and a separate five-layer structure use the cover layer 5c and the screen layer 5d and members that have no relation with the filter medium 5. Therefore, the number of components increase, and processes for attaching the cover layer 5c and the screen layer 5d are necessary, and production costs increase.

Further, the fuel filtration device 2 is formed in a bag shape by cutting the filter medium to a prescribed length and folding one filter medium, or by laying two element filters one on top of the other. When using a filter medium with a three-layer structure or a five-layer structure, the filter mediums are only fixed in place by performing heat welding at a plurality of spots as mentioned above. Therefore, for portions that are not heat welded, because each layer is a separate body, the fiber hairs 5b inevitably become raised as in FIG. 13 on the cross section of the filter medium.

Therefore, when the filter medium is formed by folding the filter medium, there is the fear that the fiber hairs 5b will become mixed in the filter medium 5 where the protector 6 is disposed, after which the fiber hairs will peel and adversely affect the fuel pump 3.

### SUMMARY OF THE INVENTION

An object of the invention is to improve the defects of an in-tank type fuel filtration device 2, in particular, to provide a fuel filtration device with lower production cost by reducing the number of components and shortening the assembly time.

A fuel filtration device according to a first embodiment of the invention includes a filter medium forming at least two opposing faces, an internal space where fluid accumulates and that is surrounded by the filter medium, and a communicating path which provides communication between the inner portion space and an outside of the inner portion, and delivers the fluid in the inner portion space to the outside of the inner portion. The filter medium is a non-woven fabric made of material fibers and adhesive fibers, and by melting the adhesive fibers, the fibers are joined.

According to the first embodiment, because it is possible to create a fuel filtration device using non-woven fabric, it is possible to reduce the weight. Also, because the adhesive fibers is melted and the fibers are joined, the raising of the fiber hair 5b shown in FIG. 13 is reduced even on the cross section of the filter medium, as well as on the surface of the fiber medium. Therefore, the peeling of the fiber hair 5b is reduced. Further, because the adhesive fibers that coat the outside periphery of the material fibers remain, the strength of the entire non-woven fabric increases, and the fuel filtration device can be formed using only the non-woven fabric. As a result, the cover layer 5c and the screen layer 5d are not always necessary.

Also, the filter medium may have a multi-layer structure in which at least two filter layers are layered. The filter medium may have an integrated structure in which the filter medium fibers and the adjacent filter layers of multi layers are joined by melting the adhesive fibers. The multi-layer structure may have a coarse and dense gradient formed by a coarse layer and a dense layer. With this structure, in a three-layer structure having a coarse and dense gradient shown in FIG. 15 as well, the cover layer 5c and the screen layer 5d are not always necessary. Further, the filter paper fibers are of course joined, and the adjacent filter layers. Therefore, the filter medium with a three layer integrated structure can be easily formed. Further, even when the filter medium with a multi-layer structure is cut, the fiber hair does not raise on the cross-section.

Also, the filter medium may be formed of a surface made of the non-woven fabric and a surface made of the mesh screen. The surface made of the mesh screen forms the bottom portion of the fuel filtration device and becomes the surface that touches the bottom wall of the fuel tank, and the durability of the surface further increases.

### BRIEF DESCRIPTION OF THE DRAWINGS

FIG. 1 is a sectional view of a fiber of the invention.

FIG. 2 is a sectional view of a single layer filter medium of the invention.

FIG. 3 is a sectional of a filter medium with a three-layer integrated structure of the invention.

FIG. 4 is a sectional view showing a fuel filtration device according to the first embodiment that is formed using a non-woven fabric of the invention.

FIG. 5 is a sectional view taken along line V to V in FIG. 4.

FIG. 6 is a plane view of the fuel filtration device in FIG. 4.

FIG. 7 is a sectional view showing the fuel filtration device according to a different embodiment of the invention.

FIG. 8 is a sectional view showing the fuel filtration device according to a second embodiment that is formed using the non-woven fabric of the invention.

FIG. 9 is a sectional view showing the fuel filtration device according to a third embodiment that is formed using the non-woven fabric of the invention.

FIG. 10 is a plane view of the fuel filtration device in FIG. 9.

FIG. 11 is a sectional view showing the installation conditions of an in-tank type fuel filtration device.

FIG. 12 is a sectional view of the in-tank type fuel filtration device.

FIG. 13 is a sectional view of the filter medium that is related art of the invention.

FIG. 14 is a sectional view of a filter medium with a three-layer separate structure that is related art of the invention.

FIG. 15 is a sectional view of a filter medium with a five-layer separate structure that is related art of the invention.

### DETAILED DESCRIPTION OF PREFERRED EMBODIMENTS

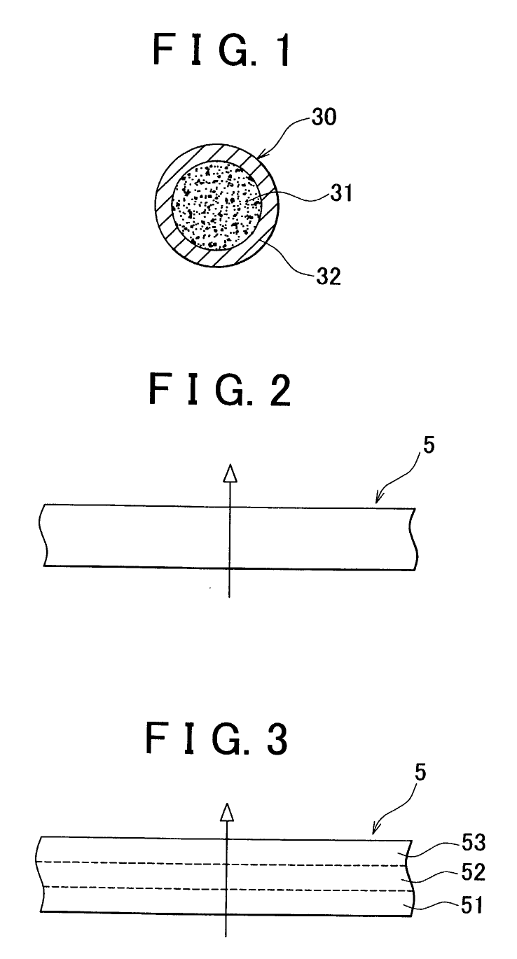

FIG. 1 is a sectional view of one fiber of the invention, FIG. 2 is a sectional view of a single layer filter medium of the invention, and FIG. 3 shows a sectional view of a filter medium with a three-layer integrated structure of the invention. The invention has the characteristic of using a fiber shown in FIG. 1.

In other words, a fiber 30 is made of a material fiber 31 of a central portion and an adhesive fiber 32 that coats the outside periphery of the material fiber 31. The material fiber 31 is formed from polyester, polypropylene, rayon, glass, acetate, and the like. For the adhesive fiber, for example, modified polyester, modified polyethylene, modified polypropylene, nylon, or the like is used, and the adhesive coats the outside periphery of the material fiber 31 by a known technique. In this case, the melting point of the material fiber 31 is approximately 250° C., and the adhesive fiber 32 with a lower melting point, for example, 40 to 240° C., is used. The adhesive fiber 32 with such a melting point is used so that the material fiber 31 does not melt.

In the invention, the fiber 30 shown in FIG. 1 is used, and a nonwoven fabric is manufactured from the fiber 30, and by heat forming the non-woven fabric a filter medium 5 is manufactured. Next, using the filter medium 5, a fuel filtration device 2 is formed. Further, there is no need to coat all of the fibers 30 with the adhesive fibers 32, and a portion of the fibers 30 may be used as they are.

The filter medium 5 is heat formed as follows. In other words, for example, for the mixture of the material fibers that are located in the molding die and the adhesive fibers, the press process is carried out in a heated atmosphere such as a high temperature bath. Alternatively the mixture is placed in a heated molding die and the press process is carried out. By this method, the mixture of the material fibers and adhesive fibers can be easily formed into a filter medium of a desired shape. The temperature of the heated atmosphere or the heated molding die is a temperature at which at least ingredients for joining the adhesive fibers with the material fibers melt and the adhesive fibers are joined with the material fibers, for example, a temperature of 40 to 240° C.

The fiber density of the adhesive fibers after heat forming changes depending on the melting point temperature and the heating time. To lower the fiber density (in this case, there are many spaces between fibers and the filter function is sufficient, but the strength deteriorates), adhesive fibers with a low melting point are used and the heating time is shortened. On the other hand, to increase the fiber strength of the adhesive fibers (in this case, there are few spaces between fibers so the filter function is lowered, but the strength increases), adhesive fibers with a high melting point are used and the heating time is elongated. By doing so, the strength of the fibers is improved, and the fibers can be further resinated. However, the fiber density is more variable depending on the combination of melting point and heating time.

The filter medium 5 of the invention is heat formed so that it can sufficiently maintain the original filter function, while also attaining the appropriate strength so that it does not wear even when it is in friction with the a bottom wall 9 of a fuel tank 1.

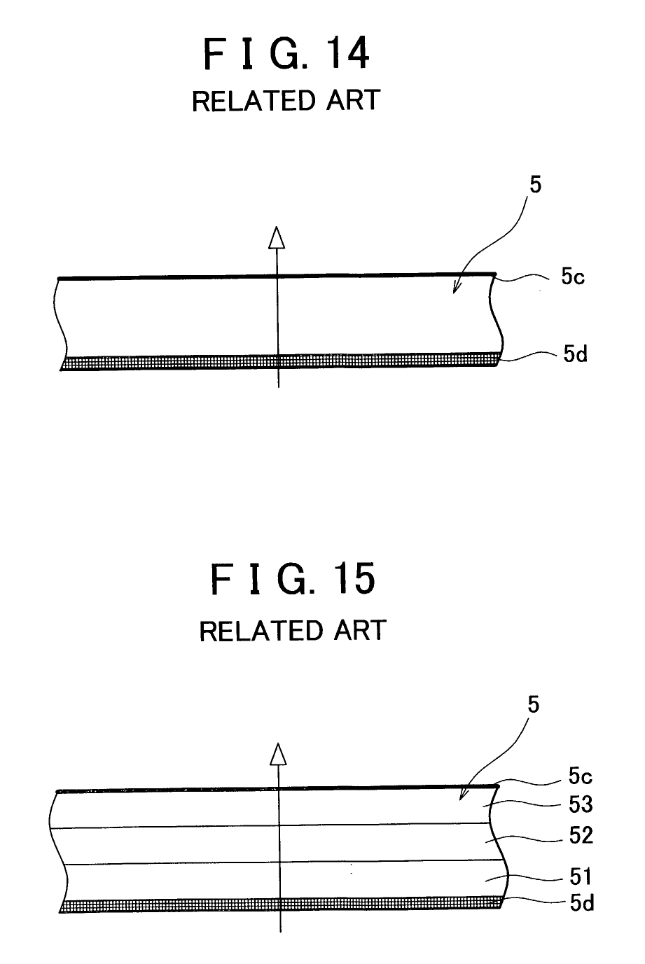

FIG. 2 shows a single layer filter medium 5. The bold outer line indicates that the fiber hair is not raised, and, therefore, a cover layer 5c and a screen layer 5d as shown in FIGS. 14 and 15 are not necessary. Further, the outlined arrow indicates the flow direction of the fuel from the outer side of the filter medium 5 to the inner side. FIG. 3 shows a filter medium with a three-layer integrated structure. The filter medium has a three-layer structure that includes a coarse layer 51, a middle layer 52 and a dense layer 53. Then, the coarse layer 51 side is the fuel tank 1 side, and the dense layer 53 side is both of the inner sides of the filter medium 5 where a protector 6 is disposed. As in FIG. 2, the fuel flows in the direction of the outlined arrow that shows the flow direction of the fuel from the outer side of the filter medium 5 to the inner side. The fuel is drawn from the coarse layer 51 side, and as it passes through the middle layer 52 and the dense layer 53, large and small foreign materials are filtered by each layer, and the fuel flows into the filter medium 5 where the protective layer is provided. When a multi-layer structure having a coarse and dense gradient is heat formed, because not only the fibers of the filter medium 5, but also the adjacent filter mediums are joined, the entire filter medium is fully integrated. In FIG. 3, the borders between each layer are shown with a bold dotted line, but the layers are joined and integrated. Naturally, the fiber hairs on the outside periphery are not raised as in FIG. 2.

Hereinafter, fuel filtration devices in various embodiments that are formed using the filter medium 5 of the invention will be explained.

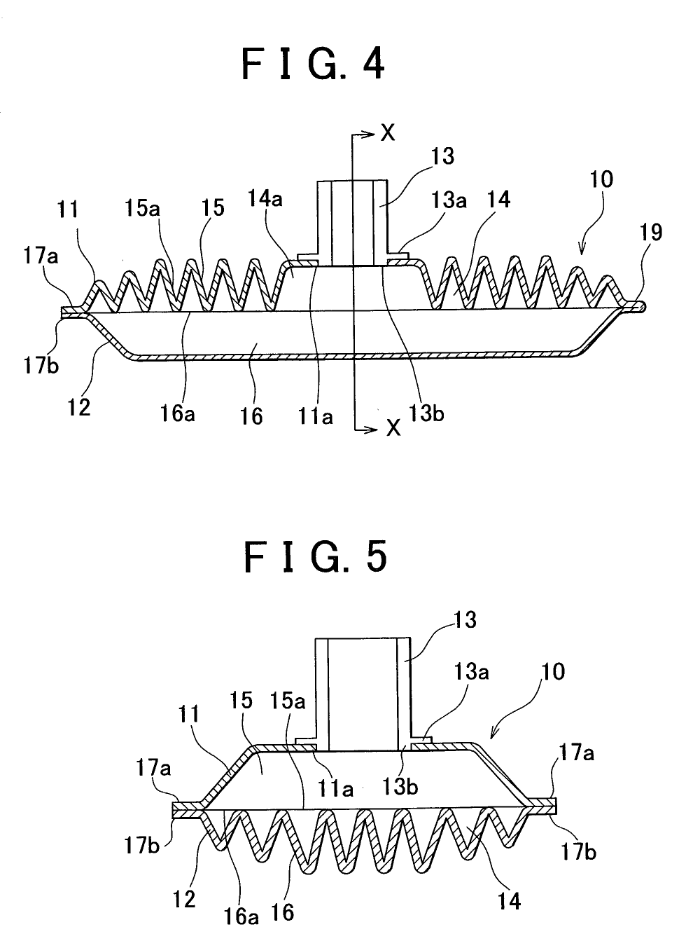

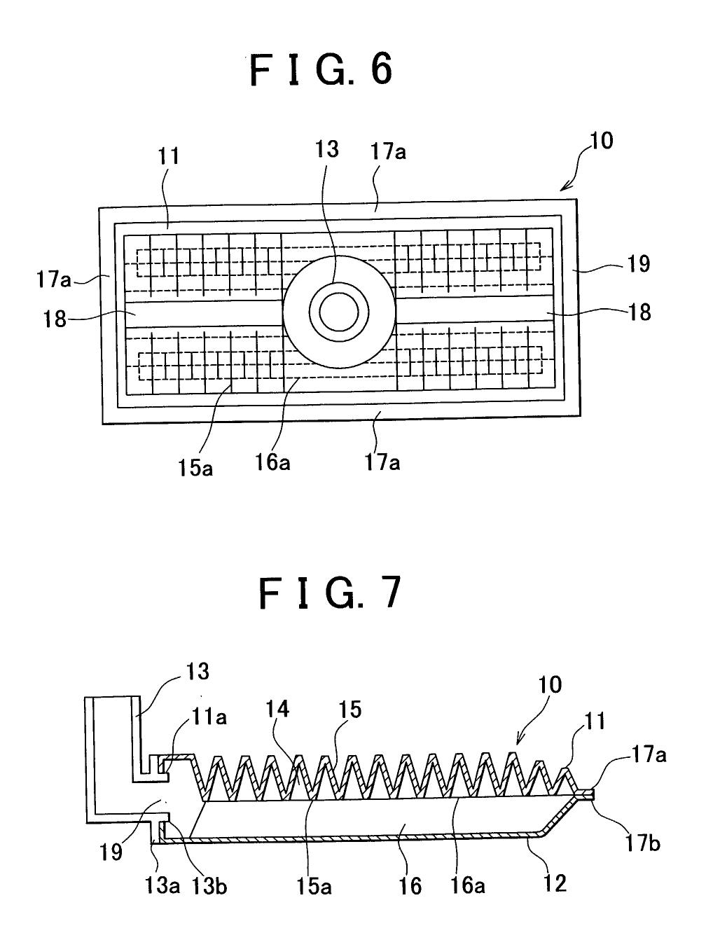

FIG. 4 through FIG. 6 show the fuel filtration device related to the first embodiment of the invention. FIG. 4 is a sectional view, FIG. 5 is a sectional view taken along line V to V in FIG. 4, and FIG. 6 is its plane view. The filtration device according to the first embodiment is formed by folding one filter medium.

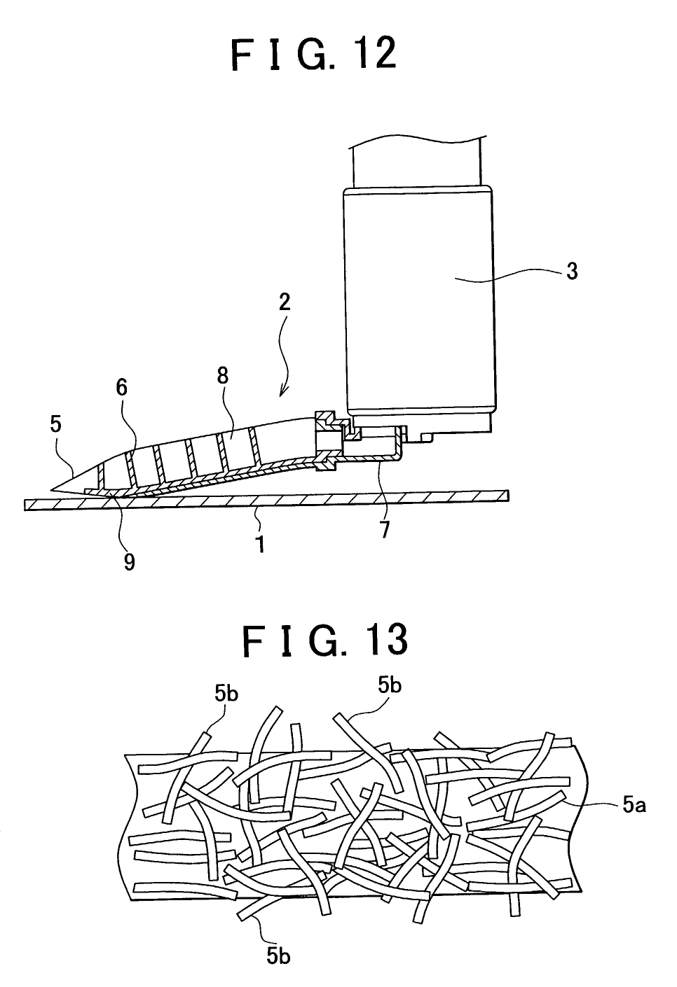

The invention will be explained as an in-tank type fuel filtration device. As shown in FIG. 6, the plane view of a fuel filtration device 10 is substantially rectangular. The fuel filtration device 10 is connected with the upstream side of a fuel pump 3 that is located in the fuel tank 1 as shown in FIG. 11 and FIG. 12 via a connecting member 13, and foreign matter in the fuel is filtered and only the filtered fuel is supplied to the fuel pump 3.

The fuel filtration device 10 is formed from one filter medium that includes a portion that is approximately one-half on the side to which the connecting member 13 is connected and a portion that is approximately one-half on the side to which the connecting portion 13 is not connected. The portion that is approximately one-half on the side to which the connecting portion 13 is connected forms an upper side filter medium 11 and the portion that is approximately one-half on the side to which the connecting portion 13 is not connected forms a lower side filter medium 12. Then, both members 11 and 12 are folded at a central folding portion 19, and overlapping periphery portions 17a and 17b are bonded using a heat melting method such as ultrasonic welding or electric welding, or they are joined using an adhesive, and an inner portion space 14 is formed in the inner portion.

The upper side filter medium 11 and the lower side filter medium 12 are formed from the non-woven fabric explained in FIG. 1 and FIG. 3, and through a method such as folding, a plurality of concavity and convexity 15 and 16 are formed in each of the filter mediums 11 and 12. As shown in FIG. 4 and FIG. 5, both of the inner side end portions 15a and 16a of the concavity and convexity 15 and 16 contact. In addition, as shown in FIG. 6, they are straight lines in the plane view, and intersect at 90° angles. The inner side end portions 15a and 16b of the concavity and convexity and 16 may simply come in contact. In order to further strengthen the filtration device, they are joined using heat welding or adhesive. By forming the upper side filter medium 11 and the lower side filter medium 12 in this kind of shape, it is possible to provide an inner portion space 14 in the inner portion of the fuel filtration device 10. As a result, because it is possible to fully secure the filtration device 11, it is possible to eliminate a protector 6 provided in the inner portion of the fuel filtration device 10 shown in FIG. 11 and FIG. 12. Of course, the protector 6 may be used as needed.

A central inner portion space 14a without concavity and convexity is formed in the central portion of the upper side filter medium, and a through hole 11a into which the end portion of the connecting member 13 can be inserted is provided on the upper side filter medium 11 of the central inner portion space. Also, a flange 13a and a tubular protruding portion 13b that extends to the end of the flange 13a are provided on the end of the connecting member 13. The tubular protruding portion 13b is inserted in the through hole 11a, and the outer surface of the upper side filter medium 11 around the through hole 11a and the surface of the flange 13a are fixed using an adhesive. The other edge of the connecting member 13 is connected to the fuel pump 3 that is located in the fuel tank 1 as shown in FIG. 1I and FIG. 12.

Further, according to the embodiment, as shown in FIG. 4 and FIG. 5, the offset angle of the inner side end portions 15a and 16a of the upper side filter medium 11 and the lower side filter medium 12 is 90 degrees. However, the intersection angle can be made smaller as long as all of the fuel that enters into the inner portion of the fuel filtration device 10 can flow until the central inner portion space 14a that is formed on the downstream side of the connecting member 13 that is integrally formed with the upper side filter medium 11.

Also, the inner side end portions 15a and 16a of both the concavity and convexity 15 and 16 are straight lines in the plane view, but may also be a curved line or a zigzag. Also, the shape of the filter medium is not limited to the rectangular shape shown in FIG. 6, and may be square or circular. In the above, the example using the non-woven fabric that was explained using FIG. 1 and FIG. 3 for the upper filter medium 11 and the lower filter medium 12 was explained. The upper filter medium 11 uses the non-woven fabric, and the lower filter medium 12 forms the lower surface of the fuel filtration device 10 and contacts the bottom wall of the fuel tank 1 with the fuel filtration device 10 positioned inside the fuel tank 1. Therefore, when the fuel tank 1 shakes from vibrations, the lower filter medium 12 comes in friction with the bottom wall 9 of the fuel tank 1, and in the worst case the lower filter medium will break. In order to reduce such adverse effects, by forming the lower filter medium 12 material from mesh screen, durability can be improved. Further, the lower filter medium 12 is formed from the non-woven fabric as shown in FIG. 1 and FIG. 3, and mesh screen may also be disposed on the outside periphery of the lower filter medium 12 that is formed from the non-woven fabric. The mesh screen may be a known coarsely woven synthetic resin screen that has many openings, or a thin flat screen with a plurality of holes.

Because the fuel filtration device 10 uses a mixture of material fibers and adhesive fibers as the non-woven fabric in such a manner, even if the concavity and convexity are integrally formed with the filter medium, the strength of the concavity and convexity can be improved, and the surface area can be increased by providing a plurality of concavity and convexity. In addition, because the inner portion space can be sufficiently secured due to the concavity and convexity, the fuel that entered the inner portion space from the filter mediums 11 and 12 flows quickly to the central inner portion space 14, and the intake efficiency of the fuel pump can be improved accordingly.

In the upper filter medium 11, a strip passage 18 in which the concavity and convexity for improving the fuel flow and for satisfactorily discharging the air in the fuel are not formed is provided lengthwise along the rectangle in the direction that intersects the direction of the concavity and convexity and in a symmetrical position that sandwiches the connecting member 13. Because the strip passage 18, the fuel and air that enters the inner portion space 14 flows smoothly to the connecting member 13 via the central inner portion space 14a. Therefore, even if the air enters the fuel filtration device, it is easily discharged without stopping in the concavity and convexity. Naturally, the concavity and convexity that are formed in the upper filter medium 11 can be provide in the same lengthwise direction of the rectangle as the direction of the strip passage 18, and the concavity and convexity that are formed in the lower filter medium 12 can be provided in a direction that intersects at right angles the direction in which the concavity and convexity in the upper filter medium 11. When positioning the concavity and convexity in such a manner, the strip passage 18 is not necessary.

FIG. 7 shows a modified example of the first embodiment. In the modified example, a plurality of concavity and convexity is provided on the filter medium. The filter medium is formed by folding one filter medium that has the upper filter medium 11 and lower filter medium 12 at the folding portion 19 (in FIG. 17 it is hidden by the connecting member 13). Then, the connecting member 13 is connected to the folding portion.

In other words, the fuel filtration device 10 is formed from the nonwoven fabric of the invention shown in FIGS. 1 to 3, and is formed from the upper filter medium 11 and the lower filter medium 12 that have a plurality of concavity and convexity. Both of the filter mediums 11 and 12 are formed by folding one filter medium at the folding portion 19 at the substantial center. A through hole 11a into which the end portion of the connecting member 13 can be inserted is provided on the folding portion 19. Also, a flange 13a and a tubular protruding portion 13b that extends to the end of the flange 13a is provided on the end of the connecting member 13. The tubular protruding portion 13b is inserted in the through hole 11a, and the outer surface of the upper side filter medium 11 around the through hole 11a and the surface of the flange 13a are fixed using an adhesive. After folding, as in the first embodiment, the periphery portions 17a and 17b of both filter mediums 11 and 12 are bonded using a heat welding method such as ultrasonic welding or electric welding, or they are joined using an adhesive, and an inner portion space 14 is formed in the inner portion. The other structures are the same as those of the first embodiment and will therefore be omitted.

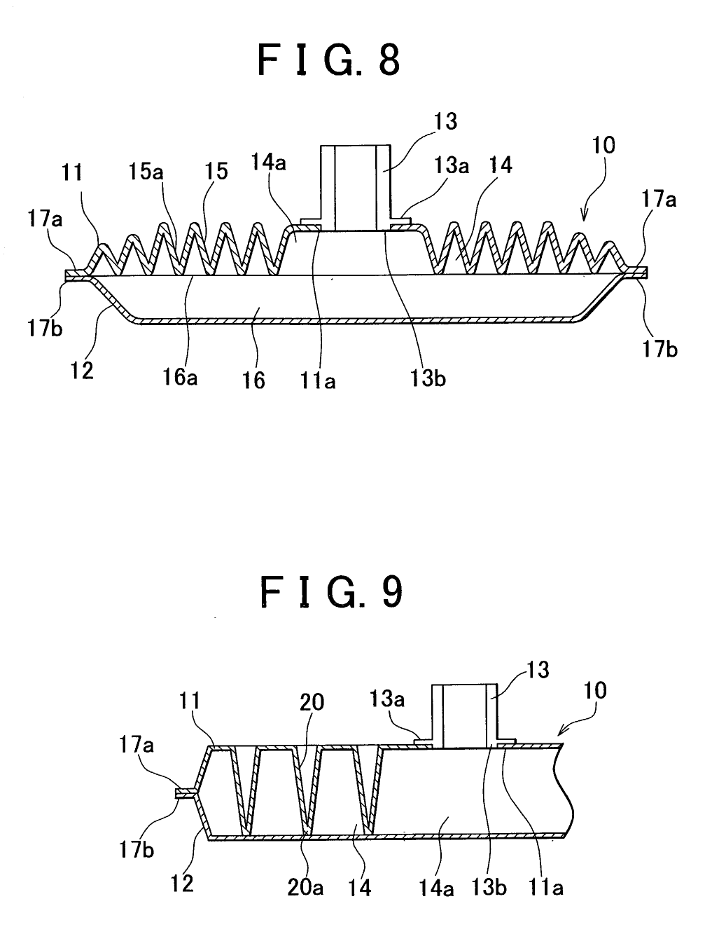

FIG. 8 shows the fuel filtration device according to the second embodiment of the invention. The difference with the first embodiment is that while in the first embodiment the fuel filtration device 10 is formed by one filter medium, in the second embodiment, the fuel filtration device 10 is formed by two filter mediums. Further, the side view and the plane view of the filtration device 10 shown in FIG. 8 are the same as in FIG. 5 and FIG. 6.

In other words, the fuel filtration device 10 is formed from two filter mediums that include a portion that is approximately one-half on the side to which the connecting member 13 is connected and a portion that is approximately one-half on the side to which the connecting portion 13 is not connected. The portion that is approximately one-half on the side to which the connecting portion 13 is connected forms an upper side filter medium 11 and the portion that is approximately one-half on the side to which the connecting portion 13 is not connected forms a lower side filter medium 12. Then, both members 11 and 12 are overlapped on top of one another. Contacting periphery portions 17a and 17b are bonded using a heat welding method such as ultrasonic welding or electric welding, or they are joined using an adhesive, and an inner portion space 14 is formed in the inner portion.

The upper side filter medium 11 and the lower side filter medium 12 are formed from the non-woven fabric explained in FIG. 1 and FIG. 3, and through a method such as folding, a plurality of concavity and convexity 15 and 16 are formed in each of the filter mediums 11 and 12. As shown in FIG. 8 and FIG. 5, both of the inner side end portions 15a and 16a of the concavity and convexity 15 and 16 contact. In addition, as shown in FIG. 6, they are straight lines in the plane view, and intersect at 90° angles. The inner side end portions 15a and 16b of the concavity and convexity 15 and 16 may simply come in contact. In order to further strengthen the filtration device, it is joined using heat welding or adhesive. By forming the upper side filter medium 11 and the lower side filter medium 12 in this kind of shape, it is possible to provide an inner portion space 14 in the inner portion of the fuel filtration device 10. As a result, because it is possible to fully strengthen the filtration device 11, it is possible to eliminate a protector 6 provided in the inner portion of the fuel filtration device 10 shown in FIG. 11 and FIG. 12. Naturally, the protector 6 may be used as needed.

A central inner portion space 14a without concavity and convexity is formed in the central portion of the upper side filter medium, and a through hole 11a into which the end portion of the connecting member 13 can be inserted is provided on the upper side filter medium 11 of the central inner portion space. Also, a flange 13a and a tubular protruding portion 13b that extends to the end of the flange 13 are provided on the end of the connecting member 13. The tubular protruding portion 13b is inserted in the through hole 11a, and the outer surface of the upper side filter medium 11 around the through hole 11a and the surface of the flange 13 are fixed using an adhesive. The other edge of the connecting member 13 connected to the fuel pump 3 that is located in the fuel tank 1 as shown in FIG. 11 and FIG. 12.

Further, according to the second embodiment, because the filter device is formed by overlapping 2 filter mediums, the material of both filter mediums can be easily changed, and in order to improve the durability of the lower filter medium 12, the material can be formed from mesh screen and the like. The other structures are the same as those of the first embodiment and will therefore be omitted.

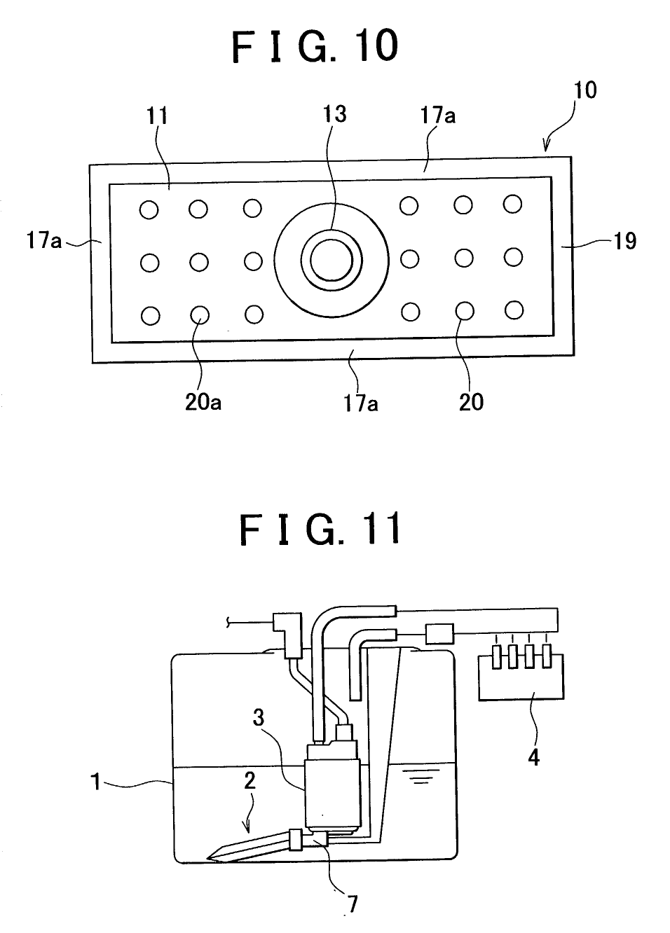

FIG. 9 and FIG. 10 show fuel filtration devices according to a third embodiment of the invention, and FIG. 9 is a partial cross section of the filtration device and FIG. 10 shows the plane view of the entire filtration device.

The third embodiment adopts a plurality of dimples in place of the plurality of concavity and convexity of the first and second embodiments. The use of the filter medium of the invention is the same as in the first and second embodiments.

In other words, as in the first and second embodiments, the fuel filtration device 10 is connected via the connecting member 13 to the upstream side of the fuel pump 3 that is located in the fuel tank 1 as shown in FIG. 11 and FIG. 12. The fuel filtration device 10 is formed from the non-woven fabric of the invention as explained with FIGS. 1 to 3. In addition, as in the first embodiment, the fuel filtration device 10 is formed with one filter medium that has an upper filter medium 11 and a lower filter medium 12. Then, both members 11 and 12 are folded at a central folding portion 19, and each overlapping periphery portions 17a and 17b are bonded using a heat welding method such as ultrasonic welding or electric welding, or they are joined using an adhesive, and an inner portion space 14 is formed in the inner portion.

The fuel filtration device 10 is formed from the non-woven fabric of the invention, and takes on a rectangular shape as shown in FIG. 10. A plurality of dimples that are conical dents are formed on the upper filter medium by a method such as applying pressure to the surface using an object with projections or the like. The end portions 20a of the dimples 20 contact the inner surface of the lower filter medium. Heat welding is performed or adhesive is applied on the contacting portion as needed, as well as on the periphery portions 17a and 17b.

According to the third embodiment, no matter how many or in what direction the contacting portions are provided, all of the fuel that enters the inner portion space 14 as shown in FIG. 10 can smoothly flow in the connecting member 13 via the central inner portion space 14a. Therefore, the protector 6 that is provided in the inner portion of the fuel filtration device 10 as shown in FIG. 11 and FIG. 12 can be omitted. Of course, the protector 6 may be used as needed.

A central inner portion space 14a without concavity and convexity is formed in the central portion of the upper side filter medium, and a through hole 11a into which the end portion of the connecting member 13 can be inserted is provided on the upper side filter medium 11 of the central inner portion space. Also, a flange 13a and a tubular protruding portion 13b that extends to the end of the flange 13a are provided on the end of the connecting member 13. The tubular protruding portion 13b is inserted in the through hole 11a, and the outer surface of the upper side filter medium 11 around the through hole 11a and the surface of the flange 13a are fixed using an adhesive. The other edge of the connecting member 13 is connected to the fuel pump 3 that is located in the fuel tank 1 as shown in FIG. 11 and FIG. 12.

Further, according to the third embodiment, an example in which the dimples 20 that are provided on the filter medium extend downward perpendicular to the upper filter medium was explained. However, they can be arranged upwards perpendicular to the lower filter medium 12, or they can be provided on both the upper filter medium 11 and the lower filter medium 12 so that they do not overlap, and, further, they may contact so that the ends overlap each other. Also, the filter medium was explained using a single folded filter medium, but two filter mediums glued together and joined may be used.

The invention is characterized by the use of adhesive fiber as the filter medium, and is not limited to the filter shapes explained above. For example, the filter may include a protector in the filter medium. Naturally, the design may be changed without departing from the spirit of the invention.

According to the embodiments of the invention, the filter medium of the fuel filtration device is formed of the non-woven fabric that includes the material fibers and the adhesive fibers, and by melting the adhesive fibers, the fibers are joined. As a result, the peeling of the fiber hairs that is caused by the raising of the fiber hairs is reduced even on a cross-section of the filter medium, as well as on the surface of the filter medium. Therefore, the cover layer that covers the surface of the filter medium can be eliminated. Further, because the adhesive fibers that coat the outside periphery of the material fibers remain, the strength of the entire non-woven fabric increases. Even if it is in friction with the bottom wall 9 of the fuel tank 1, it is durable and the screen layer of the filter medium can be eliminated. Because the cover layer or the screen layer can be eliminated in this manner, the number of components can be reduced. Also, because the assembly process for the cover layer and the screen layer can be omitted, the production process can be simplified and the production cost can be reduced. Further, because the fuel filtration device can be formed using only non-woven fabric as the filter medium, the weight of the device can be reduced.

Also, as in the above embodiments, by using a multi-layer structure in which at least two filter mediums are layered, or a multi-layer structure that has a coarse and dense gradient, for example, even in a three-layer structure that has a coarse and dense gradient, the fiber hairs are prevented from being raised on all of the outer surface. As a result, the cover layer that covers the surface of the filter medium and the screen layer can be eliminated. Therefore, the number of components in the filtration device can be reduced, the production processes simplified, and the production costs reduced. Further, because the adjacent filter mediums, in other words, the layers can be joined simultaneously, the process for joining the filter mediums can also be eliminated.

Further, the filter medium is formed by folding one plate and joining both halves of the plate, or by joining two plates. Therefore, the production of the fuel filtration device can be simplified, and the production costs can be reduced.

Also, by providing a plurality of concavity and convexity on at least one of the surfaces of the filter medium, a larger filter surface area is obtained compared to a flat filter medium. Therefore, the weight of the fuel filtration device can be reduced and the size can be decreased. Also, the strength of the fuel filtration device can be increased as a result of the concavity and convexity of the filter medium. Further, the inner portion space can be sufficiently secured due to the concavity and convexity, and the protector can be eliminated. By making the concavity and convexity into dimples, the filter medium surface area can be increased, and the strength of the fuel filtration device is increased by the concavity and convexity formed by dimples, and, further, the inner portion space can be sufficiently secured due to the dimples.

By forming the filter medium having a surface made of the nonwoven fabric and a surface made of the mesh screen, the surface that is made of the mesh screen is the bottom surface of the fuel filtration device and is the surface that comes in contact with the bottom wall of the fuel tank. Even if the fuel tank shakes due to vibrations, and the fuel tank and the fuel filtration device are in strong friction with one another, the danger of breakage therebetween can be lowered.

By providing the fuel filtration device upstream of the fuel pump, the fuel filtration to the fuel pump can be reliably carried out.

What is claimed is:

1. A fuel filtration device comprising:
a filter medium in which at lease two opposing surfaces are formed and through which liquid passes, the filter medium being a non-woven fabric that includes material fibers and adhesive fibers, the material fibers being joined by melting the adhesive fibers;
an inner portion space that is surrounded by the filter medium and in which liquid accumulates; and
a communicating path that provides communication between the inner portion space and an outside of the inner portion space and delivers the liquid in the inner portion space to the outside of the inner portion space.

2. The filtration device according to claim 1 wherein;
the filter medium includes a fiber formed by coating an outside periphery of a material fiber with an adhesive fiber.

3. The filtration device according to claim 1 wherein;
the material fibers have a melting point higher than the melting point of the adhesive fibers.

4. The filtration device according to claim 1 wherein;
the filter medium has a multi-layer structure in which at least two layers are overlapped on top of one another, and by melting the adhesive fibers, filter medium fibers and adjacent layers are joined and integrated.

5. The filtration device according to claim 4 wherein;
the filter medium has a coarse and dense gradient formed by a layer with coarse fiber density and a layer with dense fiber density.

6. The filtration device according to claim 1 wherein;
two opposing surfaces are formed by folding the filter medium.

7. The filtration device according to claim 1 wherein;
the filter medium includes a first filter medium having a first surface and a second filter medium having a second surface that faces the first surface, two opposing surfaces are formed by joining the first filter medium and the second filter medium.

8. The filtration device according to claim 1 wherein;
a plurality of concavity and convexity are provided on at least one surface of the filter medium.

9. The filtration device according to claim 8 wherein;
the concavity and convexity are dimples.

10. The filtration device according to claim 1 wherein;
the filter medium is formed by a surface made of the non-woven fabric and a surface made of a mesh screen.

11. The filtration device according to claim 1 wherein;
the filtration device is provided on an upstream side of a fuel pump.
